(19) United States
(12) Patent Application Publication
(10) Pub. No.: US 2008/0279098 A1
(43) Pub. Date: Nov. 13, 2008

(54) Wireless Receiver Code Download and Boot Sequence

(76) Inventor: Heonchul Park, Cupertino, CA (US)

Correspondence Address: Jay Chesavage, 3833 Middlefied Rd., Palo Alto, CA, 94303, US

(21) Appl. No.: 12/114,909

(22) Filed: May 5, 2008

Related U.S. Application Data
(62) Division of application No. 10/817,547, filed on Apr. 2, 2004.

(51) Int. Cl. H04L 12/26

(52) U.S. Cl. 370/230

(57) ABSTRACT

A process for initializing and booting the CPU of a wireless communication device includes a sequence controller, ROM, a ROM controller, a DMA controller, a wireless front end, a memory, and a remote wireless host which contains the download code. The sequence controller causes the ROM controller initially transfers a Source, a Destination and a Length to the DMA controller, which uses these values to copy the ROM contents into the memory. Thereafter, the sequence controller causes the CPU to start executing the code that has been transferred into memory by the ROM controller, and the CPU thereafter downloads the operating system into memory using the wireless front end, which is receiving an original and duplicate packet from the remote host. Upon completion of the download, the CPU executes the downloaded operating system and begins operation of the device.

This application is a divisional application of Ser. No. 10/817,547 filed Apr. 2, 2004. This invention relates to an apparatus and a method for the transmission and reception of code for a wireless receiver, including a booting mechanism for a Central Processor Unit (CPU).

### FIELD OF THE INVENTION

### Background of the Invention

There are several mechanisms used for providing start-up instructions and data to a Central Processing Unit (CPU) in a dedicated standalone environment, commonly known as an embedded system. The initial startup of a CPU is known as the boot sequence. One mechanism for the boot sequence is the coupling of a non-volatile memory device such as flash memory to the CPU through a shared address/data bus. Once the CPU is booted and operating, existing networking protocols allows the processor to access and download files which may reside on a device which is attached to the network. One protocol for communicating through a network is the Internet Protocol (IP), as described in the standards of the Internet Engineering Task Force (IETF at www.ietf.org). The Internet Protocol is known as a layer 3 protocol on the ISO layer model, and provides for a connection oriented packet transport interface which includes mechanisms for detecting lost packets and requesting retransmission as well as managing timeouts and transmission retry requests. One such IP protocol for transmitting files over a network is the File Transfer Protocol (FTP), as described in RFC-959 found on www.ietf.org/rfc/rfc959.txt. A simpler file transfer protocol is the Trivial File Transfer Protocol (TFTP) also known as RFC1350, described in www.ietf.org/rfc/rfc1350.txt, whereby a network device is attached to a network and requests data using the TFTP protocol which includes verification of transmission of data in a form much simpler than FTP or IP, and TFTP shares the characteristics of acknowledging received data as well as many other error and timeout conditions. A mechanism for booting a device over a network is described in RFC951 (1985), commonly known as the bootstrap protocol, or BOOT-P, and is used for assigning a network address and booting a device from a network. Both of these protocols require the network device have a layer 3 (IP) address and be capable of layer 3 (IP) communications, including retransmission. It is desired for a wireless device to utilize wireless layer 2 (MAC) frames, and to operate without an IP address, and without the IP stack being present during the downloading of data from a host. It is further desired to transfer data using fixed length frames without retransmissions requests as used in layer 3 protocols.

FIG. 1 shows a typical prior art embedded wireless system 10, which includes a CPU 12, static random access memory (SRAM) 14, dynamic random access memory (DRAM) 16, all sharing a high speed bus 28, 30, and coupled to a bridge 22. The bridge 22 couples access from the master devices such as the CPU 12 on the high speed bus 28, 30 to the long access time devices on the low speed bus 32, 34. The low speed bus 32,34 devices include the bootrom 26, wireless front end 18, and any miscellaneous devices 24 such as real time clocks (not shown), and other devices which are not time-critical for operation of the CPU 12. The high speed bus 28, 30 is generally lightly loaded to enable the highest operating speed of the CPU 12 to occur with frequently accessed devices sharing a high speed bus 28, 30. Accesses to the slower devices on the low speed bus 32, 34 from the CPU 12 are performed through the bridge 22. A typical embedded system has all of its operating software stored on the bootrom 26, such that when the CPU 12 starts, it reads data directly from the bootrom 26, and thereafter copies data and data structures from the bootrom 26 into the memories 14 and 16.

In a wireless portable device, the boot program executed by the CPU is typically stored in non-volatile memory such as flash memory bootrom 26. The flash memory typically also contains the entire operating system contents, which is copied from slow flash memory 26 to the high speed SRAM 14 or DRAM 16. Even a minimal operating system for a wireless device typically includes a bootloader which contains the CPU reset vectors, a kernel which provides basic operating system functionality and a scheduler which schedules the various threads and tasks. One such thread is typically a TCP stack, which provides the functionality of the IP (Internet Protocol) layer required by the WFE 18 which is only sending and receiving layer 2 MAC frames, and higher layer frames such as IP are handled by operating system software. In a portable wireless device 10, the battery life is often governed in part by the size of such non-volatile memory devices. In addition, once the contents of the flash memory device 26 is read by the CPU 12, the flash memory device 26 is no longer required.

It is desired to reduce the size of the non-volatile flash memory device by providing minimal functionality to the CPU from local non-volatile memory 26, and using the wireless front end 18 to download the operating system from a remote host. In this manner, a smaller non-volatile memory device 26 may be used, which reduces power dissipation and cost. The use of a smaller bootrom is possible because the bootloader is generally a smaller image than the operating system, which can be stored on a remote server.

### OBJECTS OF THE INVENTION

A first object of the invention is an apparatus for using a ROM controller and a ROM in conjunction with a bridge and a DMA controller to transfer data from a ROM to a static memory.

A second object of the invention is an apparatus for using a ROM in conjunction with a DMA controller to transfer data from a ROM to a memory.

A third object of the invention is an apparatus for using a memory in conjunction with a CPU and a wireless front end to transfer data from a wireless host to local memory.

A fourth object of the invention is an apparatus for using a wireless host and a transfer protocol for sending data from a wireless host to a local memory.

A fifth object of the invention is a process for loading an operating system with a first step of loading a SRC, DST, and LENGTH from a ROM to a static RAM, a second step of copying a ROM to a static RAM, and a third step of downloading an operating system from a host server.

A sixth object of the invention is a process for transmitting an operating system to an image, said process including the steps of a client sending a download request, a server responding to said download request with an original and duplicate packet, each original and duplicate packet having a sequence number, and transmitting said original and duplicate packet with a sequence number until the download is complete, thereafter sending a “done” packet and a duplicate “done” packet to indicate completion of the download.

### SUMMARY OF THE INVENTION

A wireless receiver 100 comprises a ROM 116 (Read Only Memory), a ROM Controller 114 coupled to the ROM 116 and also to the low speed bus 123 having an address 122 and data 124, a bridge 110 coupling the low speed data bus 123 to a high speed bus 119 having an address 118 and data 120, a DMA (Direct Memory Access) controller 126 coupled to the high speed data bus 119, along with static memory 104, dynamic memory 106, and a Wireless Front End (WFE) 108 coupled to the low speed data bus 123. The wireless front end 108 is coupled to a remote wireless host 128 which contains executable operating system code for use by the wireless receiver 100. Upon power-up, the ROM controller 114 reads the three data values SRC (Source), DST (Destination), and LENGTH from the ROM 116 and translates these three values to the address of the SRC, DST, and LENGTH registers of the DMA controller 126. The ROM Controller 114 resides on the low-speed bus 123, and the DMA controller 126 resides on the high speed bus 119. The Bridge 110 automatically couples and translates addresses and data from the low speed bus 123 to the high speed bus 119 to enable this transfer of data. Once the DMA controller 126 has these three values, it automatically begins a Direct Memory Access sequence, whereby it transfers a LENGTH number of bytes of data specified by the contents of the SRC address to the DST address. If the SRC address points to the ROM contents as accessed by the ROM controller, and the DST points to the memory such as SRAM 104, the data is automatically copied from ROM 116 to SRAM 104. The CPU 102 remains in an inactive reset state during this transfer. Once the CPU 102 is taken out of reset, it begins executing the code that was earlier copied from ROM 116 into memory 104, which also contains the bootup sequence sufficient to begin the downloading of code from the wireless host 128. The CPU 102 requests the balance of code to be downloaded from the wireless front end 108 which is coupled to a wireless host 128, and it is copied into DRAM 106. When the download is completed, the CPU has the operating system image required for full operation.

### BRIEF DESCRIPTION OF THE DRAWINGS

FIG. 1 shows the block diagram for a prior art wireless receiver.

FIG. 2 shows the block diagram for a wireless receiver according to the present invention.

FIGS. 3a and 3b show the transaction activity on the high speed bus and low speed bus for the wireless receiver boot sequence of FIG. 2.

FIG. 4 is a flowchart for the client download process.

FIG. 5 is a flowchart for the server download process.

### DETAILED DESCRIPTION OF THE INVENTION

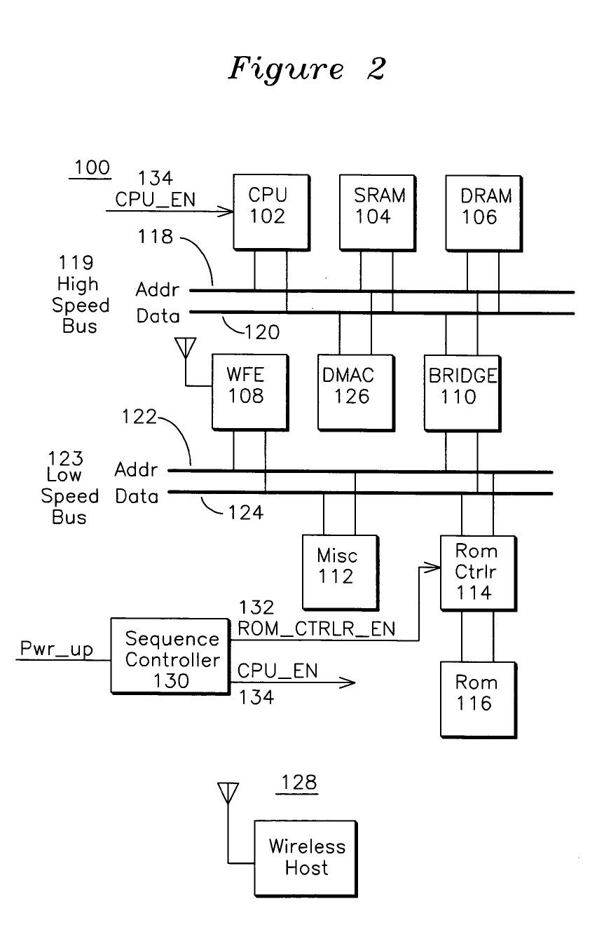

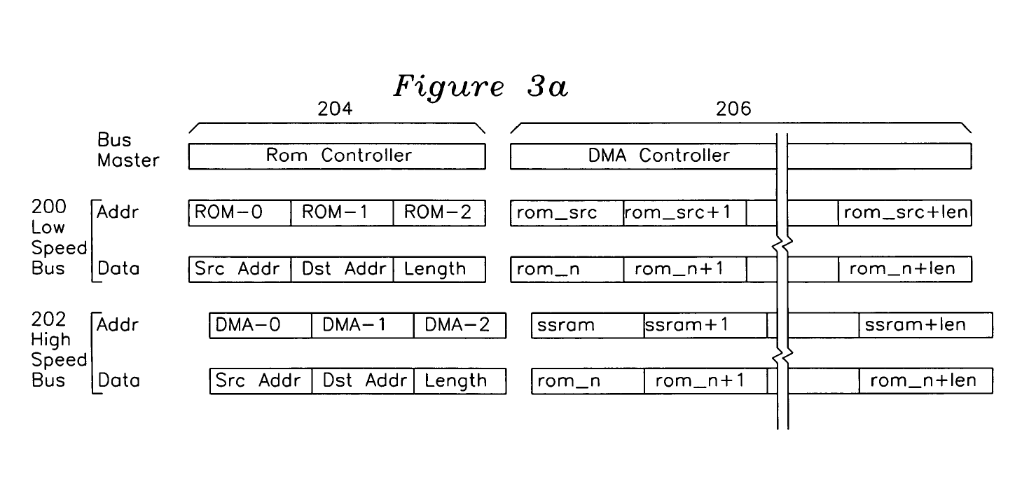

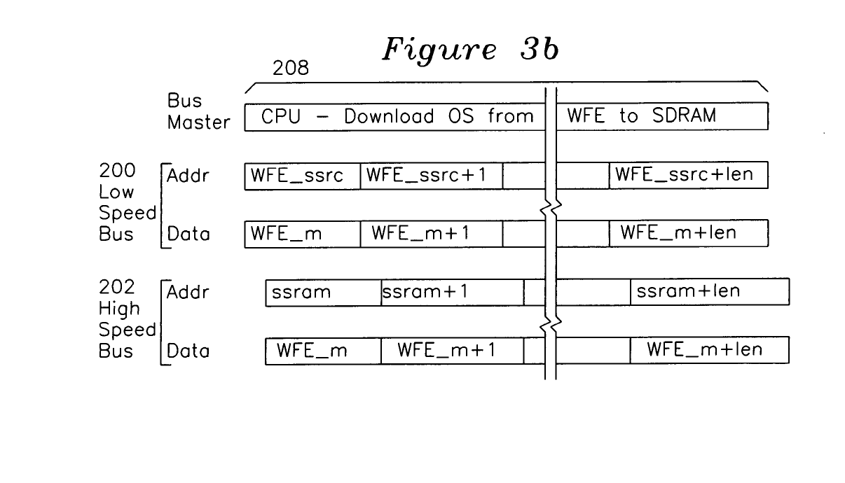

FIG. 2 shows a wireless system 100, which has a high speed bus 119 comprising an address bus 118 and a data bus 120, as is known to one skilled in the art. There may also be a low speed bus 123 comprising an address bus 122 and a data bus 124. A bridge 110 couples the high speed bus 119 to the low speed bus 123, as is known to one skilled in the art of bridges. The busses are shown with separate address and data, as may be realized in one embodiment, although the busses could also be a single multiplexed address and data bus, such as PCI (www.pci.org), or SysAd bus of R7000 (www.pmc-sierra.com). When a device is controlling a bus through the issuance of read or write requests, it is referred to as a “bus master”. Bridge 110 is bi-directional, such that bus masters may be located on the low speed bus 123 or the high speed bus 119 with contents 200 and 202, respectively, shown in FIGS. 3a and 3b. On the low speed bus 123, devices which may act as bus masters are ROM controller 114, bridge 110, and wireless front end 108. On the high speed bus 119, devices which may act as bus masters are the CPU 102 and DMA controller 126. The bridge 110 may translate addresses and data from the high speed bus 119 to the low speed bus 123, or it may preserve them, as one skilled in the prior art of big-endian and little-endian data translations, or data bus width adaptations is aware. In the present invention, bridge 110 requires no initialization, and performs the bridging bi-directionally upon power-up. A sequence controller 130 responds to a power-on signal 131, or any signal which indicates the boot sequence is to begin. The sequence controller 130 thereafter generates a ROM controller enable 132, which starts a first sequence of events, and generates a CPU EN signal 134 at a later time.

In the first part of the download sequence, upon assertion of ROM controller enable 132, the ROM controller 114 becomes bus master, and reads three values SRC, DST, LENGTH from the ROM 116, and places these values on the low speed bus 123 with the address corresponding to the address of the SRC, DST, and LENGTH registers of the DMA controller 126. With these three cycles bus-mastered by the Rom Controller 114, the DMA controller is initialized with the SRC address corresponding to the start location of program memory in ROM 116, the DST address corresponding to a high speed memory such as SRAM 104, and the LENGTH of the transfer, indicating how many bytes of data to transfer. FIG. 3a shows this transaction with the ROM controller 114 as bus master on the low speed bus 123 sending the SRC, DST and LENGTH data to the DMA controller 126 registers DMA-0, DMA-1, and DMA-2 during first sequence 204.

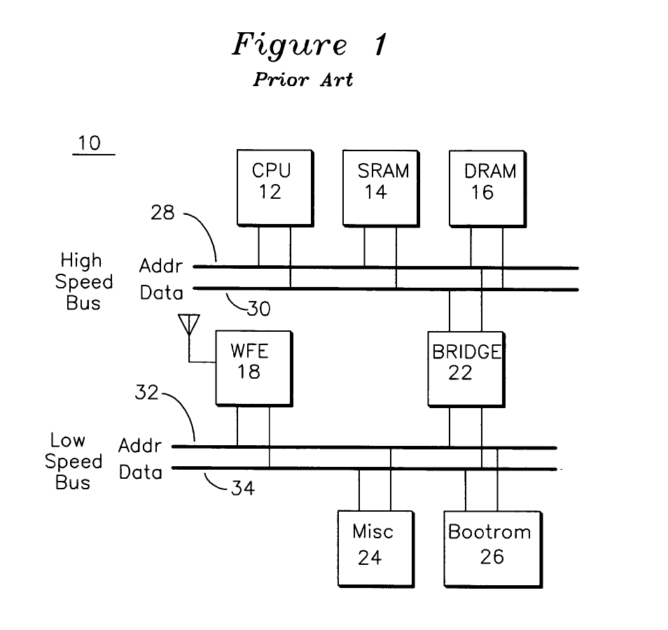

In the second part of the download sequence, the DMA controller 126 uses the SRC (DMA-0), DST (DMA-1), and LENGTH (DMA-2) register values transferred from the earlier sequence to automatically transfer the balance of the data from ROM 116 to memory, shown as SRAM 104, although it would also be possible to copy data to the DRAM 106 by changing the DST address from that of the SRAM 104 to a range occupied by DRAM 106. This is shown in FIG. 3a as sequence 206, which transfers LENGTH bytes of data from the ROM to the SRAM 104. Following the last transfer of data from ROM, the DMA controller 126 removes itself as bus master of the low speed bus 123 and high speed bus 119. At some point thereafter, the sequence controller 130 asserts CPU enable 134, which may be achieved by de-asserting a CPU reset line (not shown), as is typically done in the prior art of resetting the processor of FIG. 1.

The third part of the download sequence begins upon assertion of CPU enable 134, and the CPU 102 begins executing instruction cycles from the program data placed in SRAM 104 by the DMA controller 126 from the second sequence previously described. The third part of the sequence 208 is also shown in FIG. 3b, where the CPU boots, initializes, and starts downloading additional code for the entire operating system from a wireless host such as host 128 of FIG. 2. The download sequence uses the redundant transmission of data packets, which are reassembled into the complete code block transfer.

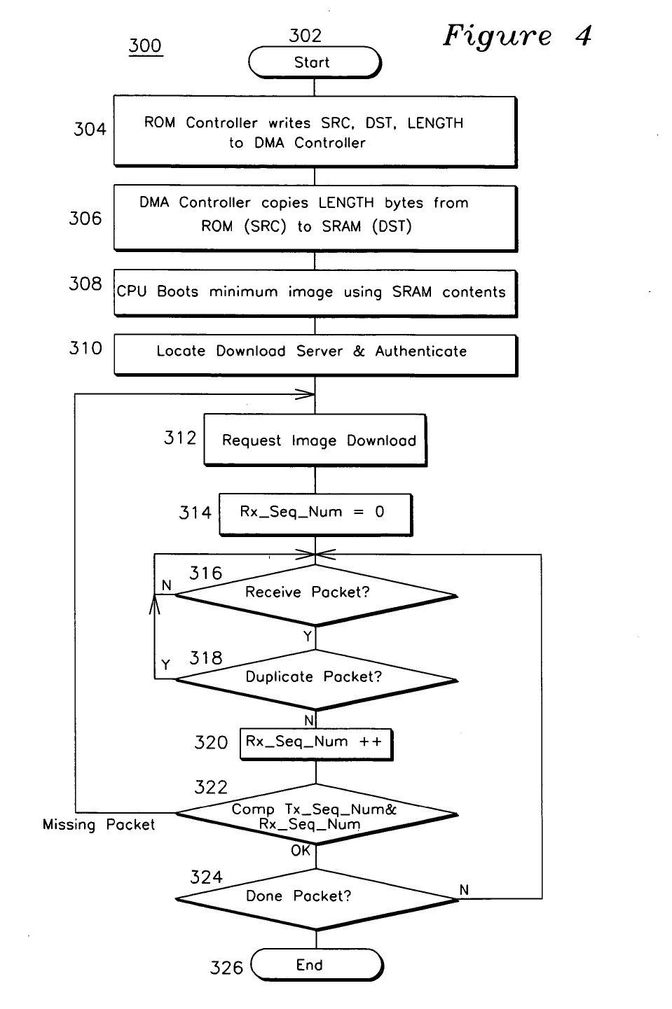

The flowchart for the client download process 300 is shown in FIG. 4. The client download process starts 302 at step 304, whereby the SRC, DST, and LENGTH are written from the ROM to the DMA controller by the ROM controller, and step 304 corresponds to first sequence 204 of FIG. 3a. The second step 306 of the download process is the copying of data from the ROM of length LENGTH to the SRAM which is addressed by the DST value written in the first step. The second step 306 corresponds to second sequence 206 of FIG. 3a. The third step of FIG. 4 corresponding to the CPU download 208 of FIG. 3b comprises the steps from 308 through 326 of FIG. 4. In step 308, the CPU enable signal has been unasserted, and the CPU boots from the SRAM contents, which contains a minimum image required for booting and the download which occurs in the following steps. Once the CPU is booted and the wireless front end is initialized to send and receive wireless packets in step 308, step 310 is performed where a download server is located and the client authenticates itself to the download server by presenting a MAC address, or any method of authentication which allows the download server to determine that a particular client should receive download code. Once the server location and client authentication step 310 is completed, the client sends a “download request” packet in step 312. Each packet received from the wireless front end includes a sequentially increasing “TX_Seq_Num”, which is the sequence number of the packet sent by the download server and received by the client. Each download data packet comprises an original packet and a duplicate packet, where both packets contain the same sequence number Tx_Seq_Num. The redundant sending of identical packets reflects the unique wireless operating condition that each packet is a separate receive event, subject to unique channel bit error rate degradation of the communication channel. While two packets are shown, it is possible to transmit any number of redundant packets. For the case of two packets, if the rate of packet corruption or loss is 1/n, the sending of a redundant packet reduces the error rate to 1/n². The client does not confirm receipt of packets, as is known to one skilled in the art of UDP packets. The client maintains a “RX_Seq_Num” value, which is incremented and compared to the TX_Seq_Num contained in the received original or duplicate packet. If the original packet is received, the duplicate packet is discarded. Step 314 shows the initialization of the receive packet sequence number Rx_Seq_Num. The Tx_Seq_Num contained in each received packet 316 is compared to the Rx_Seq_Num value to determine if it is a duplicate 318, and discarded if so. If it is the first-received packet with the proper Rx_Seq_Num, the Rx_Seq_Num is incremented by one in step 320, and if it is the second-received packet with the same Rx_Seq_Num, the duplicate packet is discarded in step 318. If a gap in the Rx_Seq_Num of received packets is detected in step 322, indicating that both an original and duplicate packet were both lost, the “image download request” packet is transmitted, starting the process over at step 312. The final packet received from the host is the “done” packet, indicating completion of transmission 324 and end of the process 326. If the packet is not a “done” packet, the process continues receiving code image packets in step 316.

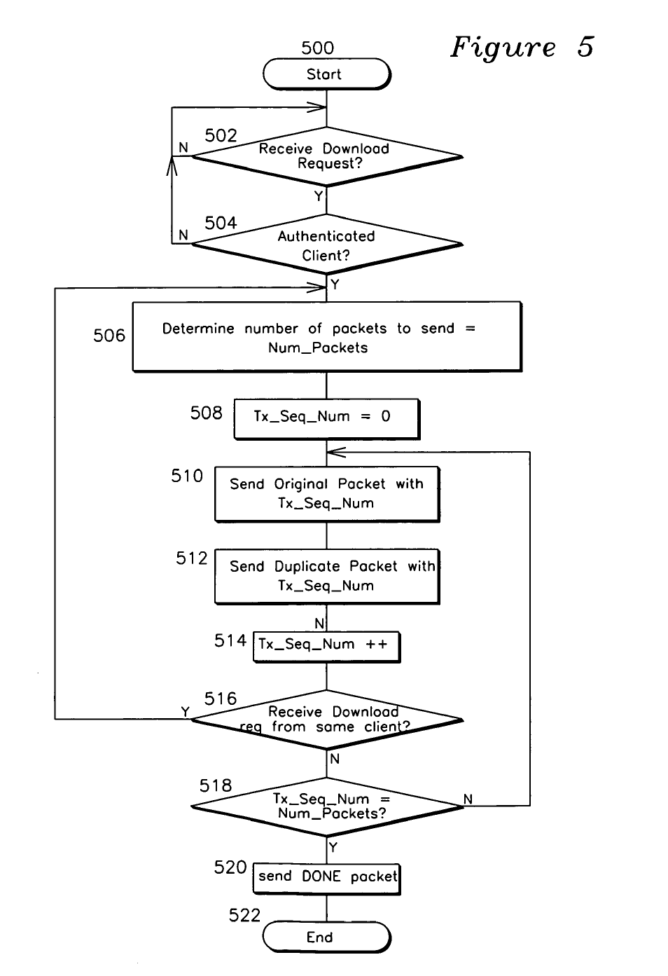

The server download process is shown in FIG. 5. The process enters at step 500 and waits for a download request 502, which is accompanied by a layer 2 MAC address, or any other authentication credentials which may be presented. These credentials are examined in step 504, and upon authentication, the host determines the number of packets to be sent and initializes Num_Packets, which indicates the number of packets to be sent. The transmit sequence number Tx_Seq_Num is initialized in step 508, and the transmission of packets starts in step 510. The transmitter sequence number Tx_Seq_Num is included in an original packet 510, as well as a duplicate packet 512 which is sent an interval of time later, after which the sequence number Tx_Seq_Num is incremented in step 514. The first interval of time between the transmission of an original and duplicate packets may be varied from 1 us to 1 s, and the second interval of time from a duplicate packet to the following original packet may be less than the first interval. In this manner, other transmission activity on the shared wireless channel may occur without collision between senders, and the likelihood of packet loss is reduced. If a download request is received from the client in step 516, this usually indicates a packet was lost during reception, and the entire download process is started again at step 506. If the Tx_Seq_Num is equal to the Num_Packets in step 518, this indicates that all of the packets have been transmitted, and the process is completed. The completion is made known to the client by sending a DONE packet in step 520, and the process exits in step 522.

FIG. 5 shows a download process from a server whereby each data includes an original packet and a duplicate packet, and the transmitter continues until the last packet, which is a DONE packet, while the receiver examines each packet in sequence, until it reaches the DONE packet, and issues a new download request if it detects any missing packets. There are other ways of accomplishing the download involving original and duplicate packets. In another embodiment, the download comprises all original packets, each with an increment Tx_Seq_Num, followed by the DONE packet, followed by the duplicate packets, each with an increment Tx_Seq_Num, followed by the DONE packet. In this manner, the original and duplicate packets are transmitted, although in a non-interleaved manner, whereby the FIG. 5 download interleaves the original packet and duplicate packet, each with the same Tx_Seq_Num and data, and the alternate embodiment sends all original packets and the done packet, followed by the duplicate packets and the done packet. In both schemes, the original and duplicate packets carry the same Tx_Seq_Num and data, but are sent in different sequences.

The described processor operating system download process and apparatus may be realized in many different ways in accordance with the invention, and is not to be restricted to the specific embodiments shown as examples. As is known to one skilled in the art, address busses such as address bus 118 and address bus 122 of FIG. 2 are used to uniquely select devices attached to the address bus, and within those devices responding to applied addresses, the address is further used to uniquely select register or memory locations within those devices. While the LENGTH field may be used to transfer a series of adjacent, or contiguous, data values, it is also possible to transfer any arrangement of contiguous, or non-contiguous values, such as described in the second part of the download process in 206 of FIG. 3a, or 306 of FIG. 4.

1-19. (canceled)

20. A process responsive to a download request from a client, said process for transmitting a block of data as a sequential packet data through a wireless transmitter, each said packet data containing a part of said block of data, said process including the steps:
a first step of transmitting each said sequential packet data as an original and a duplicate packet, each said original and duplicate packet having a Tx_Seq_Num with the same value, each said subsequent packet data also comprising an original and duplicate packet having the same said Tx_Seq_Num, which is distinct from that of any other said sequential packet data;
a second step of transmitting a DONE packet after transmission of the last said sequential packet data of said block of data.

21. The process of claim 20 where said original packets are transmitted in sequential order, each said original packet sent accompanied by said Tx_Seq_Num, followed by said DONE packet, followed by a sequence of said duplicate packets, each accompanied by said Tx_Seq_Num, followed by said DONE packet.

22. The process of claim 20 where each said original packet is followed a variable interval of time later by said duplicate packet, each said original and corresponding said duplicate packet having the same said Tx_Seq_Num.

23. The process of claim 20 where each said subsequent original packet associated said Tx_Seq_Num has a value that is one greater than the value of said Tx_Seq_Num associated with a previous said original packet.

24. The process of claim 20 where each said subsequent duplicate packet associated said Tx_Seq_num has a value that is one greater than the value of said Tx_Seq_Num associated with a previous said duplicate packet.

25. The process of claim 20 where said Tx_Seq_Num indicates the sequential order of said block of data, and at least one of said original packets or at least one of said duplicate packets is transmitted in a non-sequential order.

26. The process of claim 20 said process re-starts at said first step upon the receipt of a new said download request from the same said client.

27. A process responsive to a download request for data from a client, the process:
a first step of setting a Tx_Seq_Num to a first value;
a second step of forming a plurality m of sequential packets from said data;
a third step of sending a first said packet a plurality k times, where k is greater than 1, each said sent packet accompanied by said Tx_Seq_Num value, thereafter incrementing the value of said Tx_Seq_Num;
a fourth step of sending the remainder of said sequential packets k times, each said packet accompanied by said Tx_Seq_Num value, thereafter incrementing said Tx_Seq_Num value;
a fifth step of sending a DONE packet;
where upon receipt of a new download request for the same said data from the same said client, said process stops and re-starts at said first step.

28) The process of claim 27 where said k is increased when a new download request from the same said client is received before a previous request for the same data has completed.

29) The process of claim 27 where said Tx_Seq_Num first value is 0;

30) The process of claim 27 where the value of said Tx_Seq_Num associated with the last packet transmitted is k.

31) The process of claim 27 where an interval between transmitted packets is increased when a new download request from the same said client is received before a previous request for the same data has completed

32) The process of claim 27 said k is increased and the interval between transmitted packets is increased when a new download request from the same said client is received before a previous request for the same data has completed.

33. A process responsive to a download request for data from a client, the process having:
a first step of setting a Tx_Seq_Num to a first value;
a second step of forming a plurality of sequential packets from said data;
a third step of performing the following steps k times:
sending a first said packet accompanied by said Tx_Seq_Num value, thereafter incrementing the value of said Tx_Seq_Num;
sending the remainder of said sequential packets, each accompanied by said Tx_Seq_Num value, and incrementing said Tx_Seq_Num value after sending each said packet;
sending a DONE packet;
a fourth step of where k is greater than 1;
said process restarting from said first step if said client makes a new download request for the same said data before said done packet is sent.

34) The process of claim 33 where said k is two or three.

35) The process of claim 33 where said Tx_Seq_Num first value is 0;

36) The process of claim 33 where the value of said Tx_Seq_Num associated with the last packet transmitted is k.

37) The process of claim 33 where said k is set to a larger value if the same said client makes a request for the same said data before said DONE packet is sent.

38. Program instructions operable for executing a download request for data from a client, the program instructions having:
a first step of setting a Tx_Seq_Num to a first value;
a second step of forming a plurality m of sequential packets from said data;
a third step of sending a first said packet a plurality k times, where k is greater than 1, each said sent packet accompanied by said Tx_Seq_Num value, thereafter incrementing the value of said Tx_Seq_Num;
a fourth step of sending the remainder of said sequential packets k times, each said packet accompanied by said Tx_Seq_Num value, thereafter incrementing said Tx_Seq_Num value;
a fifth step of sending a DONE packet;
where upon receipt of a new download request for the same said data from the same said client, said program instructions begin execution from said first step.
